(19) United States
(12) Patent Application Publication
(10) Pub. No.: US 2013/0283567 A1
(43) Pub. Date: Oct. 31, 2013

(54) IMAGE FORMING APPARATUS

(71) Applicant: CANON KABUSHIKI KAISHA, Tokyo (JP)

(72) Inventor: Yoshimasu Yamaguchi, Kawasaki-shi (JP)

(73) Assignee: CANON KABUSHIKI KAISHA, Tokyo (JP)

(21) Appl. No.: 13/827,543

(22) Filed: Mar. 14, 2013

(30) Foreign Application Priority Data
Apr. 26, 2012 (JP) 2012-101864

(51) Int. Cl. E05D 7/10; E05D 3/02

(52) U.S. Cl. CPC E05D 7/1044; E05D 3/02
USPC 16/260; 16/387

(57) ABSTRACT

A hinge mechanism arranged between a main body and a door, and openably and closably supporting the door, comprising: a fixed-side hinge plate disposed at the main body; and a movable side hinge plate disposed at the door, wherein the fixed-side hinge plate includes a bearing surface and a plurality of projection portions projected from the bearing surface, and the fixed-side hinge plate is mountable to (1) a first mounting portion of the main body, having holes through which the projection portions can be inserted, and being capable of abutting to the bearing surface, and (2) a second mounting portion of the main body, being capable of abutting to end surfaces of the plurality of projection portions.

### BACKGROUND OF THE INVENTION

1. Field of the Invention

The present invention relates to an image forming apparatus, such as a copying machine and a printer.

2. Description of the Related Art

In an image forming apparatus in which a door is openably and closably mounted via a hinge portion, there is one in which the door is opened to open a sheet conveyance path.

A variety of methods, such as clamping screw, removing a rotation axis, separable hinge with a removable and insertable rotation axis, are used for a structure of a detachable door.

In addition, there is a separable hinge having a lock mechanism which can separate the hinge only when moving to an end portion of rotation.

Japanese Utility Model Laid-Open No. 63-191802 discloses a hinge having a slit in a hinge shaft in which a plate-like axial pin is insertably and removably attached.

Japanese Patent Laid-Open No. 2007-211490 discloses a pin-removal stopper attached to a hinge pin.

Japanese Patent Laid-Open No. 10-030373 discloses a lift-off hinge having a flat surface on a shaft where an adjusting screw is formed to fix with screw fastening.

Japanese Patent Laid-Open No. 2004-339850 discloses a structure which allows a position of a hinge shaft to be adjusted without requiring a covering to be detached and attached.

Japanese Patent Laid-Open No. 10-317775 discloses a structure in which using a lever to move a hinge pin makes a door possible to be detached and attached.

The conventional arts described above have following disadvantages.

In a case where a common hinge portion is used in a plurality of positions having various heights between a hinge bearing surface of a door and a surface of an outer covering in an image forming apparatus, it is necessary to complete a structure, using a single type of hinge in all positions. This has been brought from considerations to promote commonality and standardization of molds so as to reduce costs to be invested in manufacturing molds for mass production. Using a single type of hinge, however, creates level differences on an outer surface.

In order to avoid the level differences, adjusting heights is tried by inserting a sheet-like spacer. Upon attachment, then, there may be cases in which a mounting position may be displaced by impact loads during door opening-and-closing inspections in a rough manner.

In addition, increase of component parts results in increasing the number of tolerances to be accumulated in terms of dimensional tolerance, so that accuracy varies accordingly. Further, increase of the number of component parts results in increasing molds for mass production, and also becoming a factor to increase costs in general-purpose property.

In view of the problems described above, it has been desired not to increase the number of component parts by adding spacers to be inserted, or the like. There have also been disadvantages in that if the problems are to be solved by other parts, such as a framework, it is necessary to apply complex bending or draw forming processes, which are technically difficult, and yet make difficult to obtain accuracy.

### SUMMARY OF THE INVENTION

The present invention has been made to solve the problems described above, and it is desirable to provide an image forming apparatus using an applicable hinge portion.

In an exemplary structure of the image forming apparatus according to the present invention for achieving the above object, a hinge mechanism arranged between a main body and a door, and openably and closably supporting the door, comprising: a fixed-side hinge plate disposed at the main body; and a movable side hinge plate disposed at the door, wherein the fixed-side hinge plate includes a bearing surface and a plurality of projection portions projected from the bearing surface, and the fixed-side hinge plate is mountable to (1) a first mounting portion of the main body, having holes through which the projection portions can be inserted, and being capable of abutting to the bearing surface, and (2) a second mounting portion of the main body, being capable of abutting to end surfaces of the plurality of projection portions.

Further features of the present invention will become apparent from the following description of exemplary embodiments with reference to the attached drawings.

### BRIEF DESCRIPTION OF THE DRAWINGS

FIG. 1 is a cross-sectional explanatory view illustrating a structure of an image forming apparatus according to the present invention;

FIG. 2 is a perspective explanatory view of a door and a hinge portion provided in the image forming apparatus according to the present invention, as viewed from an inner surface side;

FIG. 3 is a perspective explanatory view of the door and the hinge portion provided in the image forming apparatus according to the present invention, as viewed from an outer surface side;

FIG. 4A is an exploded perspective view illustrating a structure in which a mounting bearing surface of a side of an image forming apparatus main body is provided with clearance holes, in a first embodiment of the image forming apparatus according to the present invention;

FIG. 4B is an enlarged plan view illustrating a structure of a mounting portion of a hinge shaft;

FIG. 5 is an exploded perspective view illustrating the structure in which the mounting bearing surface of the side of the image forming apparatus main body is provided with the clearance holes for inserting projection portions, in a first embodiment;

FIG. 6 is an exploded plan view illustrating the structure in which the mounting bearing surface of the side of the image forming apparatus main body is provided with the clearance holes for inserting the projection portions, in the first embodiment;

FIG. 7A is an assembled plan view illustrating the structure in which the mounting bearing surface of the side of the image forming apparatus main body is provided with the clearance holes for inserting the projection portions, in the first embodiment;

FIG. 7B is an A-A cross-sectional view in FIG. 7A;

FIG. 8 is an exploded perspective view illustrating a structure in which the mounting bearing surface of the side of the image forming apparatus main body is provided with no clearance holes for inserting the projection portions, in the first embodiment;

FIG. 9 is an exploded plan view illustrating the structure in which the mounting bearing surface of the side of the image forming apparatus main body is provided with no clearance holes for inserting the projection portions, in the first embodiment;

FIG. 10A is an assembled plan and side view illustrating the structure in which the mounting bearing surface of the side of the image forming apparatus main body is provided with no clearance holes for inserting the projection portions, in the first embodiment;

FIG. 10B is an assembled plan and side view illustrating the structure in which the mounting bearing surface of the side of the image forming apparatus main body is provided with no clearance holes for inserting the projection portions, in the first embodiment;

FIG. 11A is an assembled perspective view illustrating the structure in which the mounting bearing surface of the side of the image forming apparatus main body is provided with no clearance holes for inserting the projection portions, in the first embodiment;

FIG. 11B is an enlarged plan view illustrating a structure of the mounting portion of the hinge shaft;

FIG. 12A is a plan view illustrating the structure in which the mounting bearing surface of the side of the image forming apparatus main body is provided with no clearance holes for inserting the projection portions, in the first embodiment;

FIG. 12B is a front view illustrating the structure in which the mounting bearing surface of the side of the image forming apparatus main body is provided with no clearance holes for inserting the projection portions, in the first embodiment;

FIG. 12C is a side view illustrating the structure in which the mounting bearing surface of the side of the image forming apparatus main body is provided with no clearance holes for inserting the projection portions, in the first embodiment;

FIG. 13 is an exploded perspective view illustrating a structure in which the mounting bearing surface of the side of an image forming apparatus main body is provided with no clearance holes for inserting projection portions, in a second embodiment of the image forming apparatus according to the present invention;

FIG. 14 is an exploded plan view illustrating the structure in which the mounting bearing surface of the side of the image forming apparatus main body is provided with no clearance holes for inserting the projection portions, in the second embodiment;

FIG. 15A is an assembled plan view illustrating the structure in which the mounting bearing surface of the side of the image forming apparatus main body is provided with no clearance holes for inserting the projection portions, in the second embodiment;

FIG. 15B is a B-B cross-sectional view in FIG. 15A;

FIG. 16 is an exploded perspective view illustrating a structure in which the mounting bearing surface of the side of the image forming apparatus main body is provided with the clearance holes only for inserting higher projection portions, in the second embodiment;

FIG. 17 is an exploded plan view illustrating the structure in which the mounting bearing surface of the side of the image forming apparatus main body is provided with the clearance holes only for inserting the higher projection portions, in the second embodiment;

FIG. 18A is an assembled plan view illustrating the structure in which the mounting bearing surface of the side of the image forming apparatus main body is provided with the clearance holes only for inserting the higher projection portions, in the second embodiment;

FIG. 18B is a D-D cross-sectional view in FIG. 18A;

FIG. 19 is a perspective explanatory view illustrating a structure in which the mounting bearing surface of the side of the image forming apparatus main body is provided with clearance holes for inserting both of higher and lower projection portions, in the second embodiment;

FIG. 20 is an exploded plan view illustrating the structure in which the mounting bearing surface of the side of the image forming apparatus main body is provided with the clearance holes for inserting both of the higher and the lower projection portions, in the second embodiment;

FIG. 21A is an assembled plan view illustrating the structure in which the mounting bearing surface of the side of the image forming apparatus main body is provided with the clearance holes for inserting both of the higher and the lower projection portions, in the second embodiment; and

FIG. 21B is an E-E cross-sectional view in FIG. 21A.

### DESCRIPTION OF THE EMBODIMENTS

Hereinafter, a first embodiment of an image forming apparatus according to the present invention will be specifically described with reference to the related drawings.

### Embodiment 1

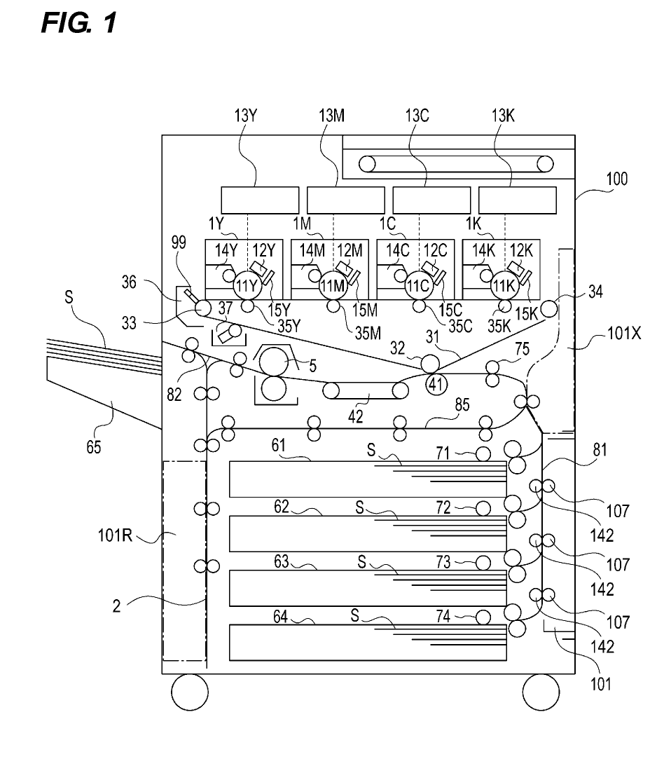

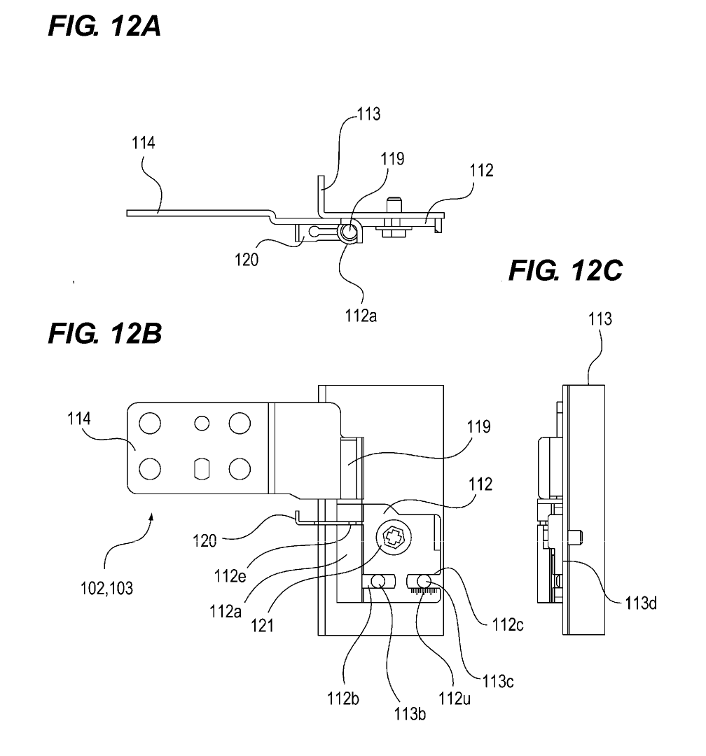

First, a description will be made of a structure of the first embodiment of the image forming apparatus according to the present invention, referring to FIGS. 1 to 12.

FIG. 1 is a cross-sectional explanatory view illustrating the image forming apparatus according to the present invention.

The image forming apparatus 100 illustrated in FIG. 1 is an apparatus for forming images, adopting a tandem-type intermediate transfer method in which image forming portions 1Y, 1M, 1C, 1K are arranged in series on a horizontal portion of an intermediate transfer belt 31. Then, according to an image information (signal) transmitted from an external device, a full-color image is formed on a sheet S by way of an electro photographic system. In the following description, the image forming portions 1Y, 1M, 1C, 1K may be represented with an image forming portion 1. Other image forming process members are also described in the same manner.

In the image forming portion 1, a toner image in each color of yellow Y, magenta M, cyan C, and black K is formed in photoconductive drums 11Y, 11M, 11C, 11K serving as image bearing members, so that a primary transfer is performed at a same image position on the intermediate transfer belt 31.

The intermediate transfer belt 31 rotates, being stretched across a driving roller 33, a tension roller 34, and a transfer opposite roller 32 for performing a secondary transfer, in a tensioned state. Each of primary transfer rollers 35Y, 35M, 35C, 35K for performing the primary transfer is arranged in a position opposite to each of the photoconductive drums 11 at an inner circumferential surface side of the intermediate transfer belt 31.

A circumference of the photoconductive drum 11Y forming a toner image of yellow Y is provided with a charging roller 12Y which uniformly charges a surface of the photoconductive drum 11Y, and an exposure device 13Y exposing the surface of the photoconductive drum 11Y to form an electrostatic latent image. Further, there are provided a development unit 14Y transferring a toner to the electrostatic latent image on the surface of the photoconductive drum 11Y to form a toner image, and a cleaning member 15Y removing toner residues on the photoconductive drum 11Y after the primary transfer of the toner image is performed.

Since a process to form toner images in each color of magenta M, cyan C, and black K is the same as that of the case where the toner image of yellow Y described above is formed, by replacing the suffix character Y in the above description with M, C, K, respectively, a repeated description per color is omitted.

On the other hand, one of conveying rollers 71, 72, 73, 74 rotates, so that a sheet S stored in sheet cassettes 61, 62, 63, 64 is conveyed to a sheet conveyance path 81. A conveying roller 142 provided at a main body side of the image forming apparatus 100 (apparatus main body side) on the sheet conveyance path 81 serving as a conveyance rotating member is rotated by a driving source, such as a motor (not illustrated), provided in the main body of the image forming apparatus 100.

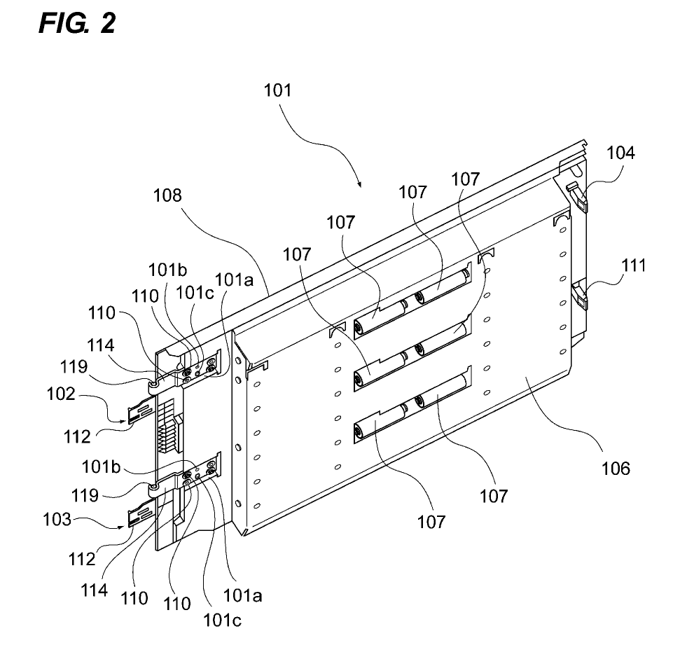

A driven roller 107 serving as a follower rotating member which is pressed onto the conveying roller 142 to be driven to rotate is provided at a side of openable and closable door 101 (door side) via hinge portions 102, 103 illustrated in FIG. 2, with respect to the main body of the image forming apparatus 100 (apparatus main body). Then, the sheet S conveyed to the sheet conveyance path 81 is nipped between the conveying roller 142 and the driven roller 107 to be conveyed.

A resist roller 75 conveys the sheet S to a secondary transfer nip portion in which a secondary transfer roller 41 and the transfer opposite roller 32 abut through the intermediate transfer belt 31, with a timing of the toner image thereon being synchronized.

Next, in the secondary transfer nip portion, the sheet S on which the toner image on the intermediate transfer belt 31 is transferred by an operation of the secondary transfer roller 41 is supported by a conveyance belt 42 to be conveyed to a fixing device 5. Then, applying heat and pressure at the fixing device 5 fixes the toner image on a surface of the sheet S, so that a full color image is deposited. The sheet S, thereafter, is discharged to a discharge tray 65 through a discharge path 82. Toner residues on the intermediate transfer belt 31 are removed by the cleaning member 99 to be stored in a waste toner container 36. Reference numeral 85 denotes a duplex conveyance path.

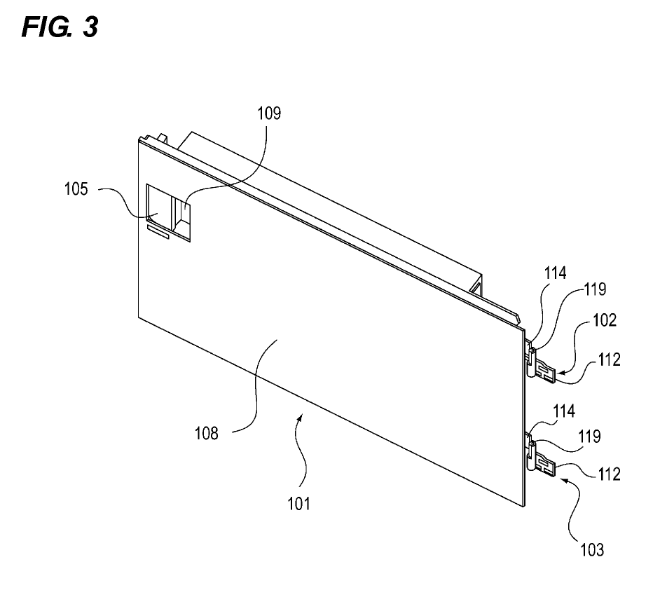

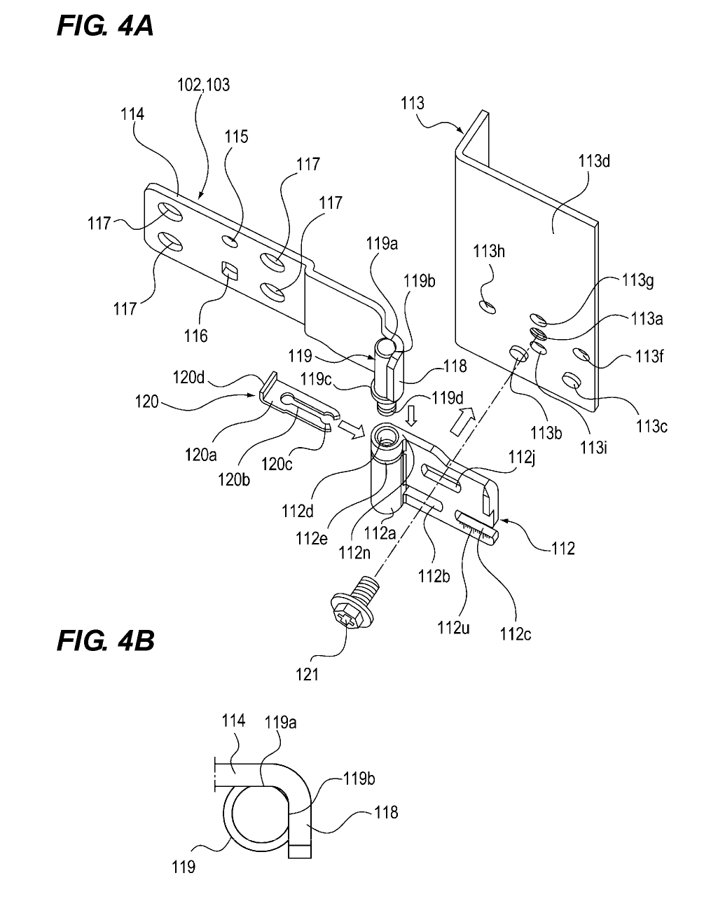

FIGS. 2 and 3 illustrate a structure of movable side hinge plates 114 of hinge portions 102, 103, which are mounted to a mounting bearing surface 101a (mounting surface) of a side of the door 101 (door side), as illustrated in FIG. 1, to form a hinge mechanism in which the door 101 is openably and closably supported, as viewed from an inner surface side and an outer surface side, respectively. FIG. 4A illustrates a structure of a fixed-side hinge plate 112 which is mounted to a mounting bearing surface (mounting surface) 113d formed on a rear side plate 113 of the main body side of the image forming apparatus 100 (image forming apparatus main body side), as viewed from an inner surface side and an outer surface side. The movable side hinge plates 114 of a pair of upper and lower hinge portions 102, 103 are fixed to the mounting bearing surfaces 101a formed on a side edge of the door 101, by threading screws 110.

A front side as an operator side of the door 101 mounted to the image forming apparatus 100 is provided with hooks 104, 111, illustrated in FIG. 2, to hold the door 101 to the image forming apparatus 100, when the door 101 is closed. The hooks 104, 111 are integrally formed with handles 105, as illustrated in FIG. 3, via a rotatable shaft (not illustrated).

As illustrated in FIG. 2, an inner side of the door 101 is provided with a conveyance guide plate 106 of the sheet conveyance path 81, and the driven roller 107 to be driven to rotate, by pressing onto the conveying roller 142 which holds the sheet S to convey to a downstream in a conveying direction.

As illustrated in FIG. 3, an outside of the door 101 is provided with an outer covering 108 made of resin. And a concave portion 109 is formed at a front side as an operator side of the door 101 in which the operator holds the handle 105 to open and close the door 101.

FIGS. 4 to 12 illustrate the structures of the hinge portions 102, 103, illustrated in FIG. 2, in the first embodiment.

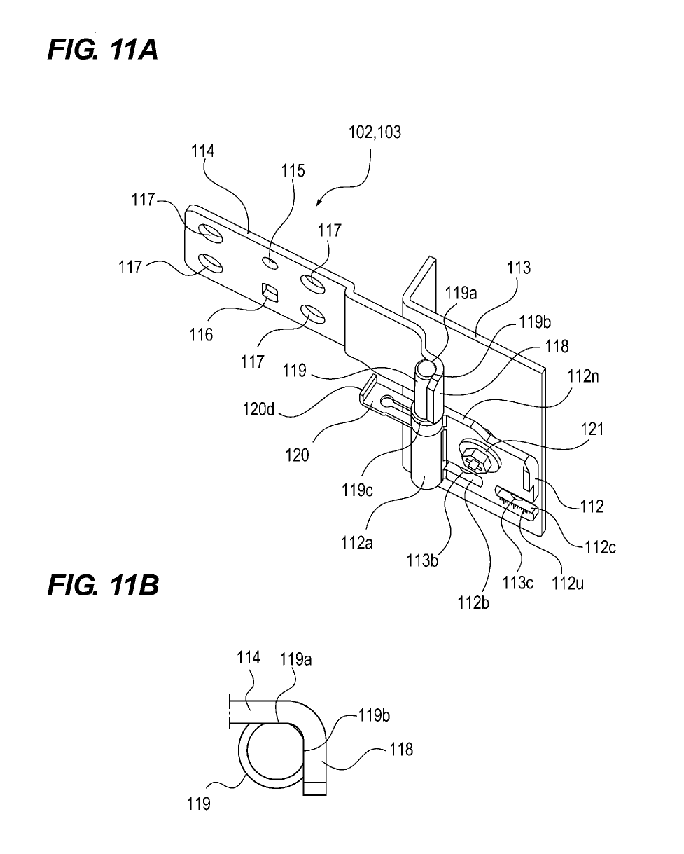

The Hinge portions 102, 103 arranged vertically at a far side of the image forming apparatus 100 are lift-off hinges. That is, as illustrated in FIGS. 4 and 11, the movable side hinge plate 114 serving as a movable side hinge member can attach to and detach from the fixed-side hinge plate 112 serving as a fixed side hinge member. The door 101 is openably and closably provided with respect to the main body of the image forming apparatus 100 via the hinge portions 102, 103 arranged vertically. The movable side hinge plate 114 forming one of the hinge plates is provided with a hinge shaft 119, serving as a rotation center of the hinge portions 102, 103, which rotate when the door 101 is opened and closed. The fixed-side hinge plate 112 serving as the other hinge plate is provided with a bearing portion 112a having a fitting hole 112d which is detachably fitted to the hinge shaft 119.

The fixed-side hinge plate 112 is fixed to the rear side plate 113 serving as a mounting bearing surface of the main body side of the image forming apparatus 100 (image forming apparatus main body side), such that one of the hinge shafts 119 of the hinge portions 102, 103 arranged vertically is removed in an upward direction before the other is removed. Further, the movable side hinge plate 114 is fixed to the mounting bearing surface 101a of the side of the door 101 (door side). The door 101, thereby, can be removed and inserted in a vertical direction in the hinge portions 102, 103 to be separated. When the door 101 is demounted from the main body of the image forming apparatus 100, the door 101 is slid along the hinge shaft 119 in an upward direction to be disengaged.

The fixed-side hinge plate 112 is a framework of the image forming apparatus 100, and is arranged close to the sheet conveyance path 81 which is formed in a right end portion in FIG. 1 of the rear side plate 113, serving as the mounting bearing surface of the main body side of the image forming apparatus 100. And the rear side plate 113 mounting the fixed-side hinge plate 112 is provided with a screw hole 113a and a plurality of guide embossments 113b, 113c.

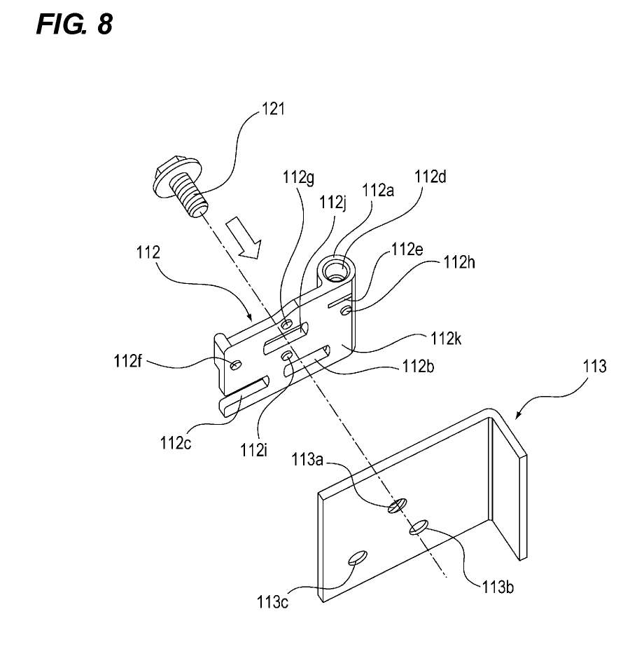

Further, as described in details hereinafter, the rear side plate 113 is used, such that clearance holes 113f to 113i are formed to insert embossments 112f to 112i, which are a plurality of projection portions formed on the fixed-side hinge plate 112, as illustrated in FIGS. 4 to 7. Further, the rear side plate 113 is used, such that no clearance holes 113f to 113i are formed thereon, as illustrated in FIGS. 8 to 10. These rear side plates are selectively used.

As illustrated in FIGS. 4 to 7, the fixed-side hinge plate 112 having the embossments 112f to 112i is fixed to the rear side plate 113 having clearance holes 113f to 113i. In this case, in addition that the embossments 112f to 112i are inserted into the clearance holes 113f to 113i in the rear side plate 113, the guide embossments 113b, 113c of the rear side plate 113 are inserted into elongated guide holes 112b, 112c of the fixed-side hinge plate 112, respectively.

Then, the fixed-side hinge plate 112 is abutted to the rear side plate 113. A screw 121, serving as a fastening member, is inserted into an elongated screw-insertion hole 112j in the fixed-side hinge plate 112 to be threadably coupled to the screw hole 113a of the rear side plate 113, so that the fixed-side hinge plate 112 is fixed to the rear side plate 113.

In a case illustrated in FIGS. 8 to 10, the fixed-side hinge plate 112 having the embossments 112f to 112i is fixed to the rear side plate 113 having no clearance holes 113f to 113i. In this case, the guide embossments 113b, 113c of the rear side plate 113 are inserted into the elongated guide holes 112b, 112c of the fixed-side hinge plate 112, respectively, to abut end surfaces of the embossments 112f to 112i of the fixed-side hinge plate 112 to the mounting bearing surface 113d of the rear side plate 113.

Then, the screw 121 is inserted into the elongated screw-insertion hole 112j in the fixed-side hinge plate 112 to be threadably coupled to the screw hole 113a of the rear side plate 113, so that the fixed-side hinge plate 112 is fixed to and spaced apart from the rear side plate 113 just by a height of the embossments 112f to 112i.

A longitudinal direction of the elongated guide holes 112b, 112c formed in the fixed-side hinge plate 112 is arranged in an orthogonal direction with respect to a central axis of the fitting hole 112d. The guide embossments 113b, 113c projectingly formed in the rear side plate 113 are inserted into the elongated guide holes 112b, 112c, respectively, so as to be movable along the longitudinal direction of the elongated guide holes 112b, 112c. The elongated screw-insertion hole 112j in the fixed-side hinge plate 112 is formed in a position corresponding to the screw hole 113a of the rear side plate 113.

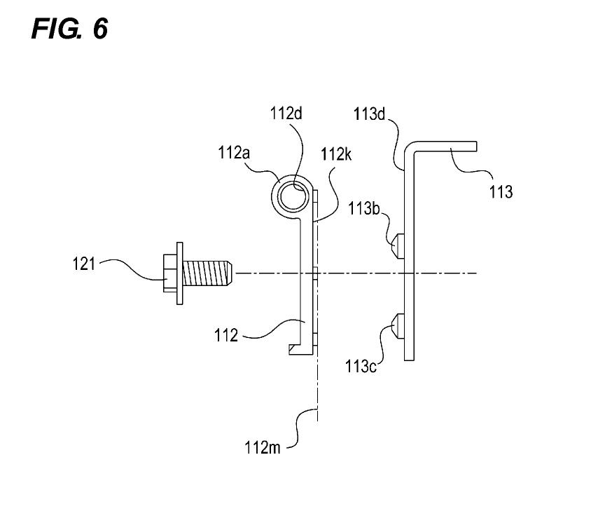

A mounting bearing surface of the fixed-side hinge plate 112 is mounted to the mounting bearing surface 113d of the rear side plate 113, which serves as the mounting bearing surface of the main body side of the image forming apparatus 100. There is provided with a first bearing surface 112k, which is formed with a rear surface of the fixed-side hinge plate 112, as illustrated in FIG. 6. In addition, the plurality of projection portions is projected from the first bearing surface 112k, forming the embossments 112f to 112i. In the structure, there is also provided a second bearing surface 112m which is formed with the end surfaces of the embossments 112f to 112i.

The rear side plate 113 (a first mounting portion), serving as the mounting bearing surface of the main body side of the image forming apparatus 100 for mounting the fixed-side hinge plate 112, has, as illustrated in FIGS. 4 to 7, the clearance holes 113f to 113i which can insert the embossments 112f to 112i formed on the fixed-side hinge plate 112, respectively. Then, the rear side plate 113 of the main body of the image forming apparatus 100 is provided with a first mounting bearing surface (a first mounting surface) which can abut to a rear surface of the fixed-side hinge plate 112, serving as the first bearing surface 112k.

As illustrated in FIGS. 8 to 10, the main body of the image forming apparatus 100 has the rear side plate 113 (a second mounting portion) having a second mounting bearing surface (a second mounting surface) which can abut to the second bearing surface 112m, which is formed with the end surfaces of the embossments 112f to 112i formed on the fixed-side hinge plate 112. By choosing between the rear side plate 113 illustrated in FIGS. 4 to 7 and the rear side plate 113 illustrated in FIGS. 8 to 10, a distant position as a mounting position of the fixed-side hinge plate 112 apart from the rear side plate 113 is adapted to be changeable.

The movable side hinge plate 114 is fixed to the mounting bearing surface 101a provided vertically in a far side of the door 101, by using the screws 110 serving as fastening members, as illustrated in FIG. 2.

The movable side hinge plate 114 is provided with a positioning round hole 115 in which a first positioning projection 101b formed on the mounting bearing surface 101a of the side of the door 101 is inserted, as illustrated in FIGS. 2, 4, and 11. There is also provided a positioning elongated hole 116 in which a second positioning projection 101c is inserted. Further, there are provided screw-insertion holes 117 to which the screws 110 are inserted to fix to the mounting bearing surface 101a of the side of the door 101.

As illustrated in FIGS. 4B and 11B, one end portion of the movable side hinge plate 114 has a right-angled rising member 118 produced by a press, to be formed in an L-shaped cross section. Substantially-right-angled abutting surfaces 119a, 119b formed on an outer circumferential surface of the hinge shaft 119 are abutted along an inner circumferential surface of the L-shaped cross section to be fixed (contact fixing) by laser welding, or the like.

In a positional relationship between the conveyance guide plate 106 formed in the door 101 and the driven roller 107, the movable side hinge plate 114 has the positioning round hole 115, serving as a positioning portion, and a positioning elongated hole 116, so as to maintain high dimensional precision and to be assembled accurately.

The positioning round hole 115 and the positioning elongated hole 116 formed in the movable side hinge plate 114 are fitted into the projections 101b, 101c formed on the mounting bearing surface 101a of the side of the door 101, respectively. Then, the screws 110 are inserted into the screw-insertion holes 117 to be threadably coupled to screw holes (not illustrated) formed in the mounting bearing surface 101a of the side of the door 101. This arrangement allows the outer covering 108, the conveyance guide plate 106, and the movable side hinge plate 114 to be integrally fixed.

The hinge shaft 119 has a flange 119c, and three surfaces of the rising member 118 of the movable side hinge plate 114 are in close-contact with abutting surfaces 119a, 119b and the flange 119c to be combined integrally by using laser welding for obtaining precision.

For example, if the movable side hinge plate 114 is connected by means of fitting in the hinge portions 102, 103, a backlash will cause fluctuations in a parallel position between the conveying roller 142 of the sheet conveyance path 81 and the driven roller 107, and variations in a biasing pressure of the driven roller 107 will occur.

In the art disclosed in Japanese Patent Laid-Open No. 10-030373 described above, both of an upper axial bearing portion and a lower axial portion are large holes in which axial portions are attached allowing a backlash to some extent, and then, it is structured so as to be held and fixed by using adjustable screws. The structure, however, has a disadvantage in that since a backlash is pressed on one side with respect to a hinge hole by screws, a rotation center is displaced just by the backlash.

According to the embodiment, the hinge shaft 119 is provided with the substantially-right-angled abutting surfaces 119a, 119b and the flange 119c, which are in close-contact with the three surfaces of the rising member 118 of the movable side hinge plate 114 to be welded by laser. This arrangement prevents a rotation center from being displaced, and solves the problem in Japanese Patent Laid-Open No. 10-030373.

On an assumption that the hinge portions 102, 103 have a backlash during operation of the image forming apparatus 100, when the sheet S is conveyed to the sheet conveyance path 81 in the image forming apparatus 100, an edge of the sheet S bumps into the conveying roller 142 and the driven roller 107 nipping the sheet S, generating a striking/bumping noise. And a rubbing noise is generated when the sheet S is nipped to pass through. Or, a slipping noise is generated with an impact when a rear end of the sheet S is ejected from the conveying roller 142. In addition, other noises such as a flipping noise at the rear end of the sheet S is generated, and the noises and vibration are propagated over the door including the driven roller 107. Vibration may be amplified in some cases.

Particularly, supposing that the door 101 is not reliably held by the hooks 104, 111 and the hinge portions 102, 103 which support the door 101, the entire door 101 will be easily subjected to vibrations. If the door 101 vibrates, not only noises are propagated to an outside of the image forming apparatus 100, but also the sheet S is conveyed with vibrations to cause adverse effects on image quality. Therefore, a need exists for a structure in which vibration can be reliably prevented, and the hinge portions 102, 103, have a high degree of precision so as to move the door 101 seamlessly and smoothly. In the embodiment, the image forming apparatus 100 is structured to satisfy the need.

The rear side plate 113, as a part of a framework of the image forming apparatus 100, has a screw hole 113a and two of the guide embossments 113b, 113c. The guide embossments 113b, 113c are embossments in a campanulate shape in which fitting dimensional tolerance is set to be about g9.

On the other hand, the fixed-side hinge plate 112 has two of the elongated guide holes 112b, 112c opposing to the guide embossments 113b, 113c, for adjusting a horizontal position. The elongated guide holes 112b, 112c have a dimensional precision of about H7 to H10 as a fitting dimensional tolerance, and the guide embossments 113b, 113c are inserted into the elongated guide holes 112b, 112c, respectively, so as to be slidably mounted along the elongated guide holes 112b, 112c. The arrangement makes a structure possible such that the fixed-side hinge plate 112 maintains a posture with respect to the rear side plate 113 of the main body of the image forming apparatus 100 with precision.

Accordingly, the fixed-side hinge plate 112 can precisely adjust positioning in a horizontal direction of the image forming apparatus 100. In addition, in a vicinity of a circumference of the elongated guide hole 112c, a scale 112u is engraved in 1 mm increments on a surface of the fixed-side hinge plate 112 to be used as an indication for adjusting a position of the fixed-side hinge plate 112 in a horizontal direction.

In the embodiment, the guide embossments 113b, 113c of the rear side plate 113 are slid along the elongated guide holes 112b, 112c of the fixed-side hinge plate 112, respectively. Then, the fixed-side hinge plate 112 can be adjusted in position along the rear side plate 113 in an orthogonal direction with respect to the central axis of the fitting hole 112d in which the hinge shaft 119 is fitted.

Even if the fixed-side hinge plate 112 is adjusted in position in a horizontal direction, the hinge shaft 119 rotatably fitted into the fitting hole 112d is held in a vertical direction of the image forming apparatus 100, thereby, the arrangement can make the structure to be prevented from tilting.

According to the embodiment, even if the fixed-side hinge plate 112 is adjusted in position in a horizontal direction, the hinge shaft 119 is held in a vertical position. For example, tilting the hinge shaft 119 leads to a tilt in the driven roller 107 formed at the side of the door 101. Accordingly, a nip portion between the conveying roller 142 arranged at the sheet conveyance path 81 of the main body side of the image forming apparatus 100 and the driven roller 107 formed at the side of the door 101 is tilted. This causes the sheet S to skew, as the sheet S is nipped to be conveyed in the nip portion between the conveying roller 142 and the driven roller 107. According to the embodiment, a conventional problem of a door tilt is solved by achieving prevention of the door 101 from tilting.

The bearing portion 112a arranged vertically in one-side end portion of the fixed-side hinge plate 112 is provided with the fitting hole 112d fitting the hinge shaft 119 formed at the movable side hinge plate 114. The central axis of the fitting hole 112d is arranged in an orthogonal direction with respect to a center line in a longitudinal direction of the elongated guide holes 112b, 112c.

There is provided a slit 112e orthogonal in a direction of the central axis of the fitting hole 112d which can insert a removal stopper plate 120 serving as a stopper member illustrated in FIG. 4, in a midstream of a direction of the central axis of the fitting hole 112d of the bearing portion 112a of the fixed-side hinge plate 112. There is also provided a removal stopper groove 119d which can seize a fitting portion 120c formed in a tip portion of the removal stopper plate 120, in an outer circumferential surface of the hinge shaft 119 corresponding to the slit 112e.

Then, the hinge shaft 119 provided in the movable side hinge plate 114 is inserted into the fitting hole 112d of the bearing portion 112a of the fixed-side hinge plate 112. The removal stopper plate 120 is inserted through the slit 112e of the bearing portion 112a, so that the fitting portion 120c of the removal stopper plate 120 is fitted into the removal stopper groove 119d of the hinge shaft 119 to stop each other in an engaged state. With this arrangement, the door 101 mounted to the movable side hinge plate 114 can be rotatably mounted with respect to the fixed-side hinge plate 112 mounted to the rear side plate 113 of the main body of the image forming apparatus 100.

According to the embodiment, the hinge portions 102, 103 are formed of lift-off hinges in which the removal stopper plate 120 is correctly fitted into the removal stopper groove 119d formed in the hinge shaft 119.

A lower portion of the hinge shaft 119 is formed having a shell shape, a hemisphere shape, or a chamfered shape, in order to make easy to conduct work for inserting into the fitting hole 112d.

The movable side hinge plate 114 according to the embodiment is formed by a press work of an electro galvanized steel sheet. The hinge shaft 119 is formed by heading a material, such as carbon steel for machine structural use (S45C), free-cutting steel bar (SUM), and stainless steel (SUS) in a cold forging operation. This can reduce the manufacturing cost, and stability in dimensional precision and high strength can be secured as well.

The fixed-side hinge plate 112 according to the embodiment is formed of a zinc die-casting material by a forging process. The fixed-side hinge plate 112, thereby, can adequately withstand a large load applied thereto by a weight of the door 101. In addition, slipperiness of the hinge shaft 119 inside the fitting hole 112d can be obtained, using a characteristic property of zinc die-cast material.

The removal stopper plate 120 is inserted through the slit 112e of the bearing portion 112a of the fixed-side hinge plate 112. Then, while the fitting portion 120c formed in the tip portion slidably fits into the removal stopper groove 119d formed in an outer circumferential surface of the hinge shaft 119 to lock a position in a vertical direction, the hinge shaft 119 is rotatably seized with respect to the fitting portion 120c.

A central portion of a flat surface portion 120a of the removal stopper plate 120 has an extending slit groove 120b extending to a tip portion of the flat surface portion 120a. This arrangement imparts elasticity to the flat surface portion 120a of the outer circumferential surface of the slit groove 120b. The removal stopper groove 119d formed in an outer circumferential surface of the hinge shaft 119 is fitted into the fitting portion 120c of the removal stopper plate 120 so as to prevent removal from the fitting hole 112d of the hinge shaft 119, with a tightening force by elasticity of the flat surface portion 120a acting to the removal stopper groove 119d of the hinge shaft 119.

A picking portion 120d arranged in a standing manner from the flat surface portion 120a is formed on one end portion of the removal stopper plate 120. While the picking portion 120d is picked with fingers, the removal stopper plate 120 is inserted in a horizontal direction with respect to the slit 112e of the bearing portion 112a of the fixed-side hinge plate 112. This allows the door 101 to be attached and to be positioned. On the other hand, while the picking portion 120d is picked with fingers, the removal stopper plate 120 is pulled out in a horizontal direction with respect to the slit 112e of the bearing portion 112a of the fixed-side hinge plate 112, so that the door 101 can be detached.

The hinge portions 102, 103, according to the embodiment, represent one example applied to opening and closing of the door 101, serving as the sheet conveyance path 81 of the image forming apparatus 100, illustrated in FIG. 1.

According to the embodiment, an arrangement is made such that either one of the hinge shafts 119 of the hinge portions 102, 103 is removed in an upward direction before the other is removed.

The door 101 is removed from the main body of the image forming apparatus 100. In this case, as illustrated in FIGS. 4 and 11, the fixed-side hinge plate 112, which is threadably coupled by the screw 121 after positioning adjustment with respect to the rear side plate 113 of the main body of the image forming apparatus 100, is not removed. Further, as illustrated in FIG. 2, the movable side hinge plate 114, which is threadably coupled by the screws 110 after positioning adjustment with respect to the mounting bearing surface 101a of the door 101, is not removed. Without removing the fixed-side hinge plate 112 and the movable side hinge plate 114, the hinge shaft 119 provided in the movable side hinge plate 114 of the door 101 is lifted integrally with the door 101 in a thrust direction of the hinge shaft 119 (axial direction of the fitting holes 112d) to detach the door 101.

The removal stopper plate 120 is arranged at a side of the conveyance guide plate 106 which is an inner side of the main body of the image forming apparatus 100 with respect to the outer covering 108 of the door 101. The arrangement can prevent the removal stopper plate 120 from an operation access from an outside, unless otherwise the door 101 is opened. In other words, an operator can not touch the removal stopper plate 120 from an outside, unless the operator tries an intentional operation for detaching the door 101 from an inside of the door 101. This can prevent the door 101 from being accidentally detached, so that the door 101 does not happen to be opened unintentionally.

The hinge portions 102, 103 are mounted in two or more positions in a vertical direction on an end portion of the door 101. In this case, a hinge-plate top surface 112n of the fixed-side hinge plate 112 of the hinge portion 102 of an upper portion side, illustrated in FIG. 4, and a bottom surface of the flange 119c of the hinge shaft 119 of the movable side hinge plate 114 abut to slide each other. On the other hand, the hinge-plate top surface 112n of the fixed-side hinge plate 112 of the hinge portion 103 of a lower portion side and the bottom surface of the flange 119c of the hinge shaft 119 of the movable side hinge plate 114 are spaced apart each other.

In the embodiment, the hinge portions 102, 103 of the upper and lower portion sides have an identical shape. In a case when a distance between the two of the fixed-side hinge plates 112 of the upper and lower portion sides is exactly the same as a distance between two of the movable side hinge plates 114 of the upper and under portion sides, it is relatively easy to detach the door 101.

When the door 101 is attached, however, the hinge shaft 119 of the upper portion side and the hinge shaft 119 of the lower portion side are positioned simultaneously to be inserted into the fitting holes 112d. In an actual operation, it is very difficult to position simultaneously the hinge shafts 119 in two different positions in a vertical direction to insert into the fitting holes 112d.

In addition, there may be a case in which the hinge shafts 119 in two different positions in a vertical direction cannot be positioned simultaneously to be inserted into the fitting holes 112d, depending on a level of precision in assembly because the door 101 and the rear side plate 113 have dimensional tolerances.

In the embodiment, after one part of the hinge shaft 119 of the hinge portion 102 of the upper portion side is inserted into the fitting hole 112d, the hinge shaft 119 of the hinge portion 102 of the lower portion side can be inserted into the fitting hole 112d. For this, the fitting hole 112d of the hinge portion 103 of the lower portion side is moved in a downward direction by at least accumulated tolerances. In the embodiment, the fitting hole of the hinge portion 103 of the lower portion side is structured in a position moving by a range of 2 mm to 4 mm in a downward direction.

In the structure described above, while the hinge shaft 119 is fixed to the movable side hinge plate 114, the hinge shaft 119 is insertable to and removable from the bearing portion 112a of the fixed-side hinge plate 112 having the fitting hole 112d. The hinge shaft 119, however, may be fixed to the fixed-side hinge plate 112, and the movable side hinge plate 114 may be provided with a bearing portion having a fitting hole into which the hinge shaft 119 is inserted.

Also in this case, one end portion of the fixed-side hinge plate 112 is formed in an L-shaped cross section, and a substantially-right-angled abutting surface formed on an outer circumferential surface of the hinge shaft is abutted along an inner circumferential surface of the L-shaped cross section to be fixed each other. In the embodiment, the removal stopper plate 120 is adapted to be capable of inserting into and removing from only one of the hinge portions 102, 103 of the upper and lower portion sides. This can improve workability.

As another example of a removal stopper member, a removal stopper pin formed by wire spring is used in place of the removal stopper plate. The removal stopper pin is inserted through the slit 112e of the bearing portion 112a of the fixed-side hinge plate 112. Then, it may be structured such that while a fitting portion formed in a tip portion of the removal stopper pin slidably fits into the removal stopper groove 119d to lock a position of the hinge shaft 119 in a vertical direction, the hinge shaft 119 is rotatably seized with respect to the fitting portion.

In addition, the removal stopper plate 120 and the removal stopper pin serving as a removal stopper member may be provided with a hook (not illustrated) for drop prevention, and when the door 101 is opened, the hook is caught in the door 101 so as to prevent drop and loss of the removal stopper plate 120 and the removal stopper pin.

FIGS. 4 to 7 illustrate a joint between the fixed-side hinge plate 112 and the rear side plate 113 in a case where the clearance holes 113f to 113i are formed in the rear side plate 113.

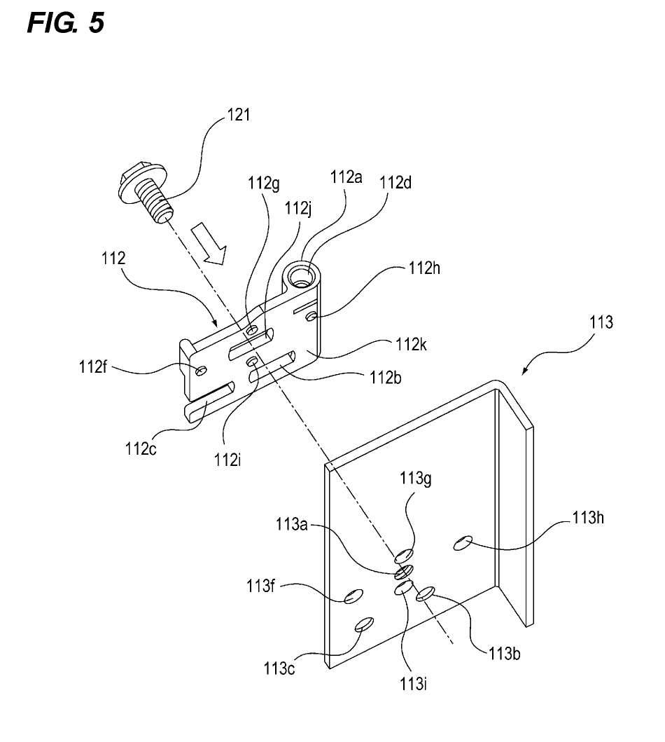

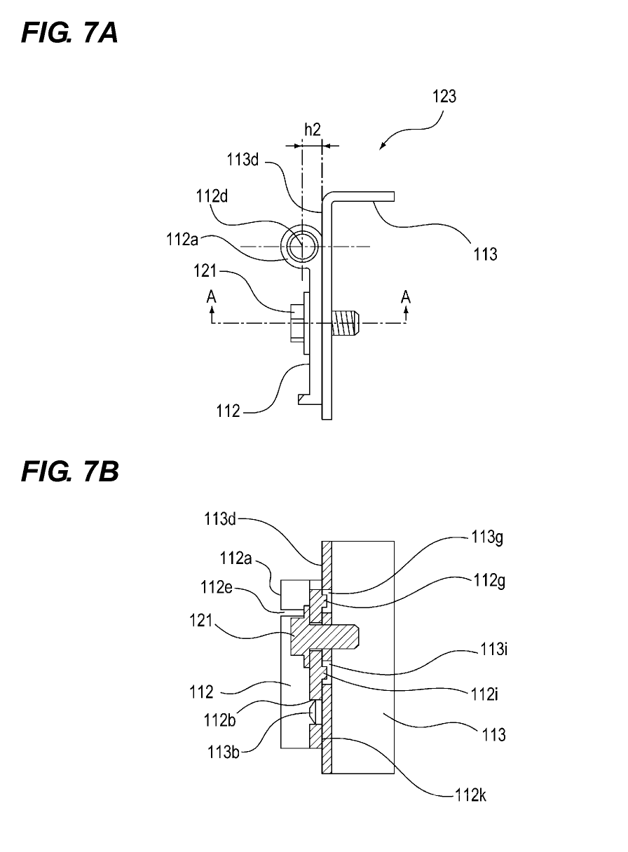

In the embodiment, it is structured such that a separation distance (joint height) of the mounting bearing surface of the fixed-side hinge plate 112 with respect to the mounting bearing surface 113d of the rear side plate 113 can be chosen from two different levels of separation distances (joint height). FIG. 7A is a plan view illustrating a state in which the fixed-side hinge plate 112 and the rear side plate 113 are joined with each other, as illustrated in the exploded views of FIGS. 5 and 6, and FIG. 7B is an A-A sectional view in FIG. 7A.

In the main body of the image forming apparatus 100, an upper door 101X is provided in a vicinity of the image forming portion 1 illustrated in FIG. 1, and can be rotated about a rotation center arranged in a perpendicular direction at a far side of the image forming apparatus, in a same manner of the door 101. The upper door 101X is also rotatably attached to the main body of the image forming apparatus 100 via the hinge portions 102, 103 having a same structure as those used in the door 101.

In the rear side plate 113 for mounting the hinge portion 102 which rotatably supports the upper door 101X, as illustrated in FIGS. 4 to 7, the clearance holes 113f to 113i are formed to insert the embossments 112f, 112g, 112h, 112i formed on the fixed-side hinge plate 112.

The upper door 101X is opened for removing a jammed sheet S at the sheet conveyance path of the image forming portion 1, or for performing maintenance on the intermediate transfer belt 31 and the image forming portion 1.

In the embodiment, the separation distance (joint height) of the mounting bearing surface of the fixed-side hinge plate 112 with respect to the mounting bearing surface 113d of the rear side plate 113 can be chosen from two different levels of separation distances (joint height).

In the hinge portions 102, 103 used in the upper door 101X in FIG. 1, the clearance holes 113f to 113i are formed in the rear side plate 113 to insert the embossments 112f, 112g, 112h, 112i formed on the fixed-side hinge plate 112, as illustrated in FIGS. 4 to 7. And, as illustrated in FIG. 7A, the separation distance between a center line passing through the fitting hole 112d of the fixed-side hinge plate 112 and the mounting bearing surface 113d of the rear side plate 113 is set to be a separation distance h2.

As illustrated in FIG. 5, the clearance holes 113f to 113i are formed in positions corresponding to the embossments 112f to 112i formed on the fixed-side hinge plate 112. As illustrated in FIG. 7B, the embossments 112f to 112i are inserted into the clearance holes 113f to 113i, respectively, so that the mounting bearing surface 113d of the rear side plate 113 and a first bearing surface 112k of the fixed-side hinge plate 112 abut each other, and are fixed with the screw 121 which is threadably coupled to the screw hole 113a.

In this case, the separation distance between a center line passing through the fitting hole 112d of the fixed-side hinge plate 112 and the mounting bearing surface 113d of the rear side plate 113 is set to be the separation distance h2 (h2<h1).

The rear side plate 113 is changed as needed between the rear plate 113 having the clearance holes 113f to 113i, as illustrated in FIGS. 4 to 7, and the rear plate 113 having no clearance holes 113f to 113i, as illustrated in FIGS. 8 to 12. Therefore, the mounting bearing surface 113d of the rear side plate 113 abuts to either one of the first bearing surface 112k as a basal portion of the embossments 112f to 112i on the fixed-side hinge plate 112 which is commonly used, and the second bearing surface 112m as the end surfaces of the embossments 112f to 112i. With the arrangement, the separation distance (height) of the hinge shaft 119 of the movable side hinge plate 114 inserted into the fitting hole 112d of the fixed-side hinge plate 112 from the mounting bearing surface 113d of the rear side plate 113 is selectably set.

With this arrangement, the common hinge portions 102, 103 can be used for doors having various heights of mounting bearing surfaces.

FIGS. 8 to 12 illustrates a joint between the fixed-side hinge plate 112 and the rear side plate 113, in a case when the rear side plate 113 has no clearance holes 113f to 113i.

In FIGS. 8 to 12, one example is illustrated in a case when in a joint structure of the fixed-side hinge plate 112 having the bearing portion 112a which the fitting hole 112d is formed to insert the hinge shaft 119 and the rear side plate 113, the rear side plate 113 abuts to the second bearing surface 112m in a high position.

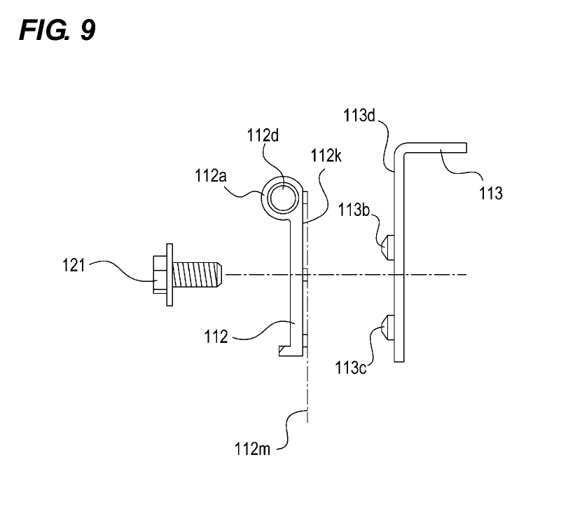

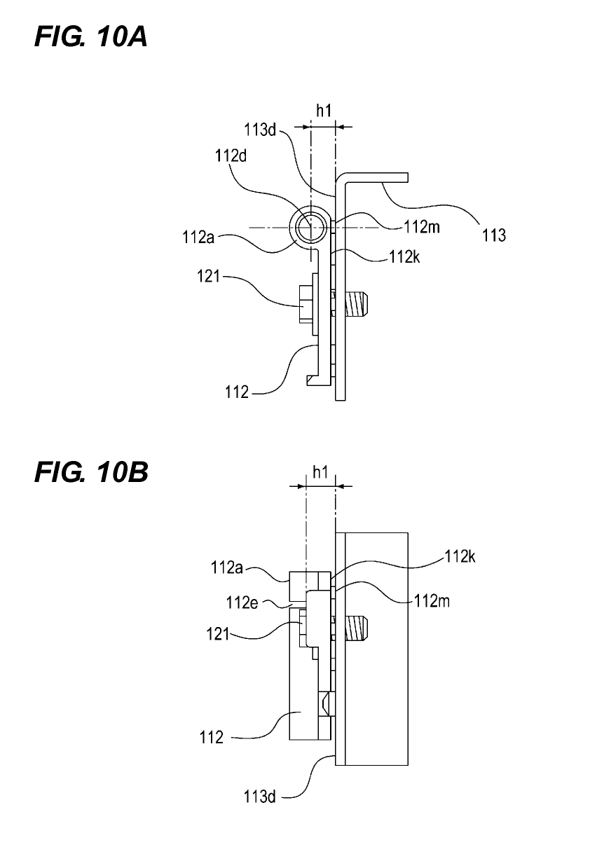

FIG. 8 shows the exploded perspective view, and FIG. 9 shows the plan view. FIGS. 10A and 10B are the plan view and the side view, respectively, illustrating the assembled state.

As illustrated in FIG. 8, the fixed-side hinge plate 112 is provided with the elongated guide holes 112b, 112c. A central portion of the fixed-side hinge plate 112 is provided with the elongated screw-insertion hole 112j. Around the elongated screw-insertion hole 112j, the embossments 112f, 112g, 112h, 112i having an identical predetermined height are formed in a thickness direction on one surface of the fixed-side hinge plate 112 facing to the rear side plate 113.

As illustrated in FIG. 9, the bearing surface facing to the rear side plate 113 of the fixed-side hinge plate 112 is provided with the first bearing surface 112k (rear surface of the fixed-side hinge plate 112) on the basal portion of the embossments 112f to 112i. Further, respective end surfaces of the plurality of embossments 112f, 112g, 112h, 112i projecting in parallel from the first bearing surface 112k are arranged on a same flat surface, which forms the second bearing surface 112m.

FIG. 9 illustrates a state in which the fixed-side hinge plate 112 and the rear side plate 113 are spaced apart each other. In FIG. 10, the second bearing surface 112m formed of the end surfaces of the embossments 112f, 112g, 112h, 112i and the mounting bearing surface 113d of the rear side plate 113 abut each other, and then, the screw 121 is threadably coupled to the screw hole 113a of the rear side plate 113. As illustrated in FIG. 10, the separation distance between a center line passing through the fitting hole 112d of the fixed-side hinge plate 112 and the mounting bearing surface 113d of the rear side plate 113 is set to be a separation distance h1 (h1>h2).

In the embodiment, a mounting position of the fixed-side hinge plate 112 can be adjusted in a horizontal direction. The driven roller 107 formed at the side of the door 101 is precisely positioned, without tilting with respect to the conveying roller 142 formed in the main body side of the image forming apparatus 100. The sheet S can be conveyed to the sheet conveyance path 81 in a straightforward manner. This can improve a degree of precision in positioning of sheet conveyance.

### Embodiment 2

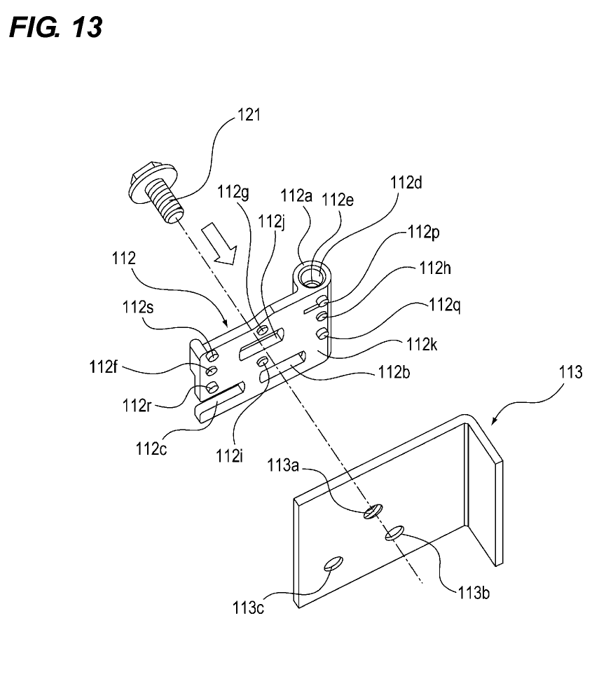

Next, a description will be made of a structure of a second embodiment of the image forming apparatus according to the present invention with reference to FIGS. 13 to 21. Portions structured in the same way as those of the first embodiment described above are given by the same reference numerals to omit those descriptions.

In the structure according to the first embodiment as described above, the separation distance (joint height) of the mounting bearing surface of the fixed-side hinge plate 112 with respect to the mounting bearing surface 113d of the rear side plate 113 can be chosen between two different levels of separation distances (joint height). In a structure according to the second embodiment, the separation distance (joint height) of the mounting bearing surface of the fixed-side hinge plate 112 with respect to the mounting bearing surface 113d of the rear side plate 113 can be chosen among three different levels of separation distances (joint height).

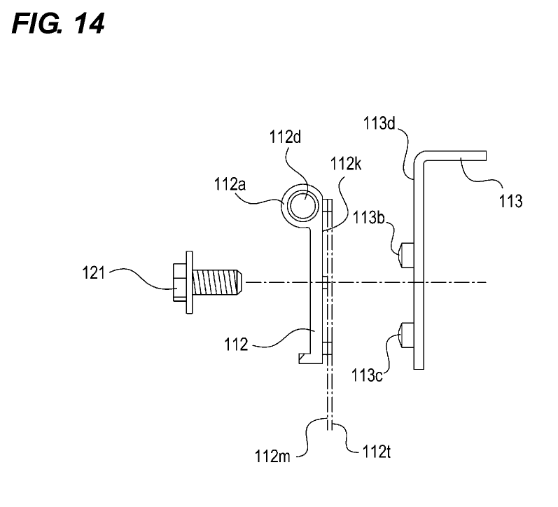

As illustrated in FIG. 14, the mounting bearing surface of the fixed-side hinge plate 112 facing to a side of the rear side plate 113 is provided with the bearing surface 112m formed of the end surfaces of lower-height embossments 112f to 121i which are a plurality of projection portions projected from the first bearing surface 112k. Similarly, there is provided a bearing surface 112t formed with the end surfaces of higher-height embossments 112p, 112q, 112r, 112s which are a plurality of projection portions projected from the first bearing surface 112k. A second bearing surface is structured in which the bearing surfaces 112m, 112t are formed with various levels of bearing surfaces varying at least in height.

In the second embodiment, a description is made of a structure, as one example, in which the separation distance (joint height) of the mounting bearing surface of the fixed-side hinge plate 112 with respect to the mounting bearing surface 113d of the rear side plate 113 can be chosen among three different levels of separation distances (joint height). The structure is adapted to have embossments having a plurality of different heights formed on the fixed-side hinge plate 112, and clearance holes formed in the rear side plate 113 for inserting the embossments.

In addition, the structure can be adapted in which the separation distance (joint height) of the mounting bearing surface of the fixed-side hinge plate 112 with respect to the mounting bearing surface 113d of the rear side plate 113 can be chosen among n levels (n=4, 5, 6 . . . ) of more than three different levels of separation distances (joint height).

The fixed-side hinge plate 112 is provided with a plurality of projection portions to form embossments having different heights, such that various levels of heights are formed by respective embossments, and each of the bearing surfaces is formed with a flat surface by using the end surfaces of the embossments having an identical height. Further, the mounting bearing surface 113d of the rear side plate 113 is provided with clearance holes accordingly, which can insert those embossments.

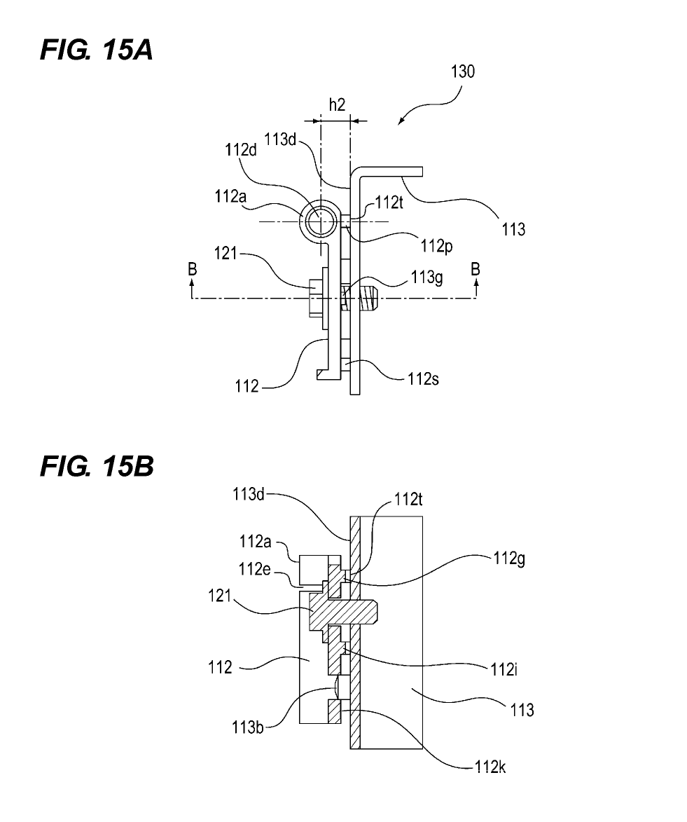

FIGS. 13 and 14 illustrate a structure in which the mounting bearing surface of the rear side plate 113 has no clearance holes which can insert the lower embossments 112f to 112i or the higher embossments 112p to 112s. FIG. 13 is an exploded perspective view and FIG. 14 is a plan view. FIG. 15A is a plan view illustrating an assembled state of the fixed-side hinge plate 112 and the rear side plate 113 illustrated in the exploded views in FIGS. 13 and 14. FIG. 15B is a B-B cross-sectional view in FIG. 15A.

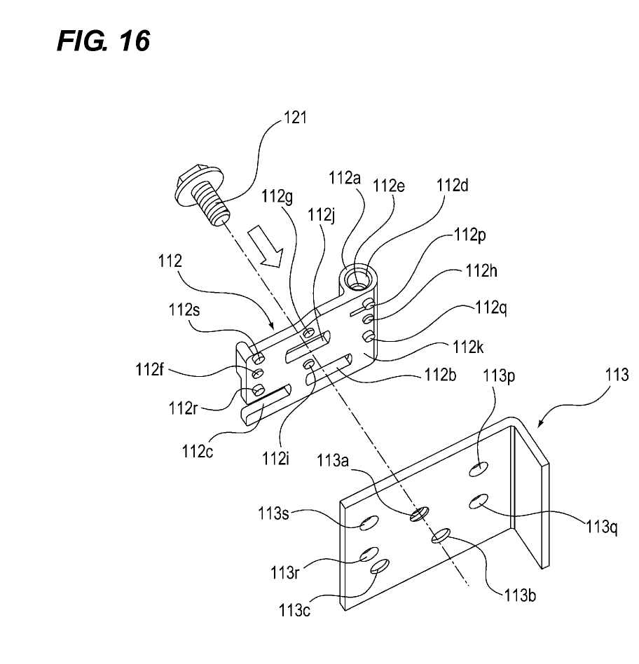

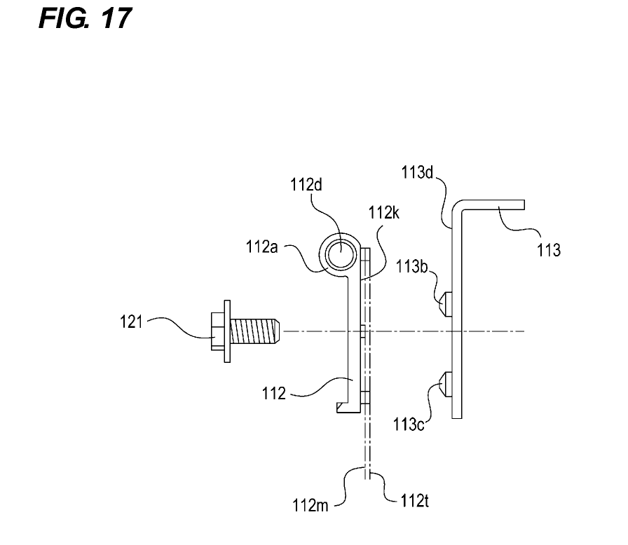

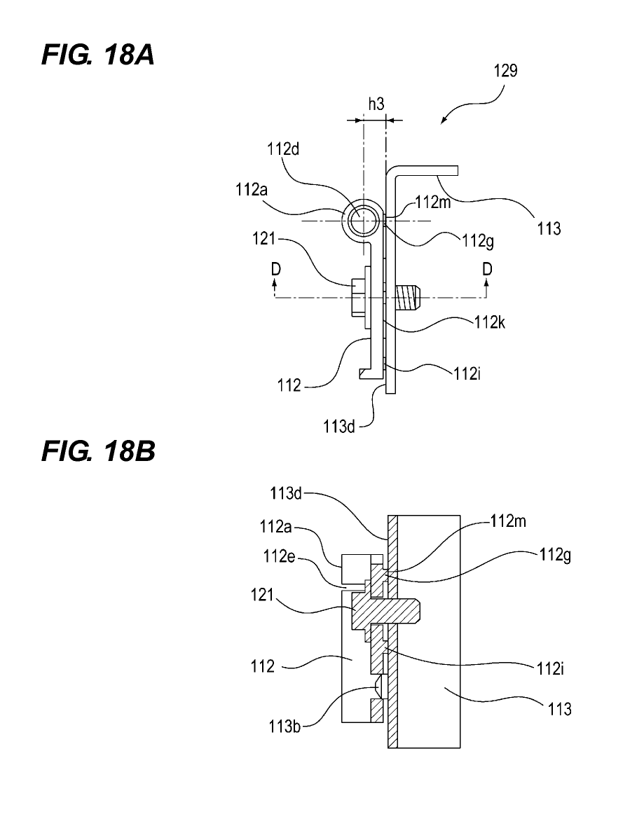

FIGS. 16 and 17 illustrate a structure in which the mounting bearing surface 113d of the rear side plate 113 is provided with the clearance holes 113p, 113q, 113r, 113s, which can insert the embossments 112p to 112s, respectively. FIG. 16 is an exploded perspective view, and FIG. 17 is a plan view. FIG. 18A is a plan view illustrating an assembled state of the fixed-side hinge plate 112 and the rear side plate 113, illustrated in the exploded views in FIGS. 16 and 17. FIG. 18B is a D-D cross-sectional view in FIG. 18A.

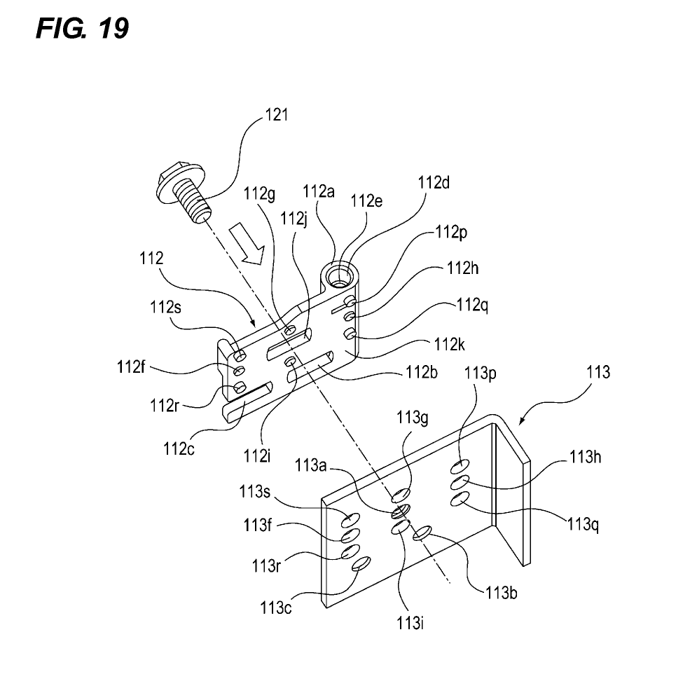

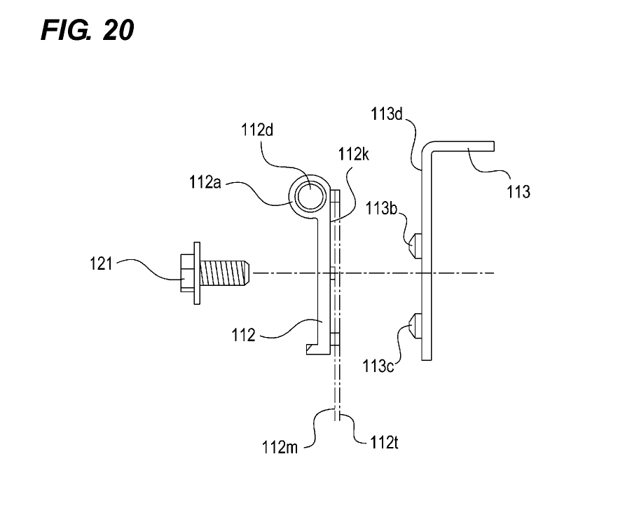

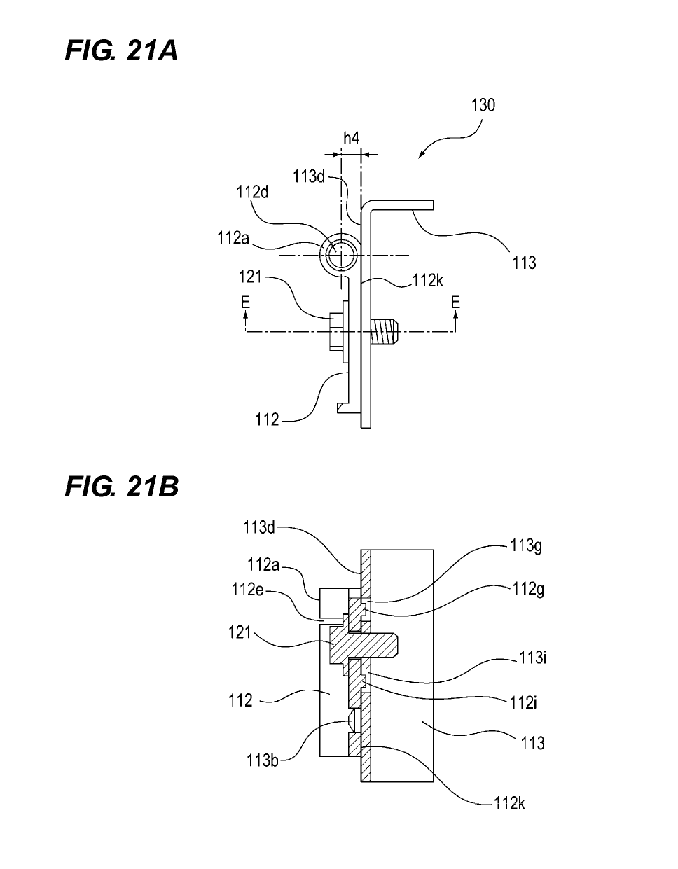

FIGS. 19 to 21 illustrate a structure in which the mounting bearing surface 113d of the rear side plate 113 is provided with the clearance holes 113p to 113s and 113f to 113i, which can insert the lower embossments 112f to 112i and higher embossments 112p to 112s, respectively. FIG. 19 is an exploded perspective view, and FIG. 20 is a plan view. FIG. 21A is a plan view illustrating the assembly state of the fixed-side hinge plate 112 and the rear side plate 113, illustrated in the exploded views in FIGS. 19 and 20. FIG. 21B is an E-E cross-sectional view in FIG. 21A.

In FIGS. 13 to 15, the fixed-side hinge plate 112 is provided with the bearing portion 112a in which the fitting holes 112d are formed to fit the hinge shaft 119 provided in the movable side hinge plate 114. Further, the elongated guide holes 112b, 112c which longitudinal direction is arranged in an orthogonal direction with respect to an axial direction of the fitting hole 112d are formed, being aligned in a straight line. Further, the elongated screw-insertion hole 112j is formed to insert the screw 121.

According to the embodiment, the lower embossments 112f to 112i and the higher embossments 112p to 112s are formed with a plurality of projection portions having various heights in a thickness direction of the fixed-side hinge plate 112 on a surface of a side facing to the rear side plate 113 of the fixed-side hinge plate 112. Then, the mounting bearing surface of the fixed-side hinge plate 112 with respect to the mounting bearing surface 113d of the rear side plate 113 can be chosen from two levels of different heights, in which the bearing surface 112m is formed with the end surfaces of the lower embossments 112f to 112i and the bearing surface 112t is formed with the end surfaces of the higher embossments 112p to 112s.

As illustrated in FIGS. 13 and 14, the first bearing surface 112k (rear surface of the fixed-side hinge plate 112) is formed on the basal portion of the embossments 112f to 112i, 112p to 112s which are formed on the surface of the side facing to the rear side plate 113 of the fixed-side hinge plate 112. The first bearing surface 112k is provided with the embossments 112f to 112i, 112p to 112s which are projected therefrom around the elongated screw-insertion hole 112j in eight directions.

The plurality of lower embossments 112f to 112i are projected in parallel from the first bearing surface 112k, and are arranged around the elongated screw-insertion hole 112j in four directions, such that the end surfaces of the lower embossments 112f to 112i are aligned on a flat surface which is formed as the second bearing surface 112m.

The plurality of higher embossments 112p to 112s are projected in parallel from the first bearing surface 112k, and are arranged around the elongated screw-insertion hole 112j in four directions and between two each of the lower embossments 112f to 112i, such that the end surfaces of the higher embossments 112p to 112s are aligned on a flat surface which is formed as the third bearing surface 112t.

The guide embossments 113b, 113c are arranged at the rear side plate 113 in a horizontal direction of the main body of the image forming apparatus 100. The guide embossments 113b, 113c are inserted into the elongated guide holes 112b, 112c of the fixed-side hinge plate 112, respectively, to be movably fitted into the elongated guide holes 112b, 112c.

The screw 121 is inserted into the elongated screw-insertion hole 112j to be threadably coupled to the screw hole 113a formed in the rear side plate 113. With this arrangement, the fixed-side hinge plate 112 can be locked and fixed to the rear side plate 113.

In the structure illustrated in FIGS. 13 to 15, the mounting bearing surface 113d of the rear side plate 113 has no clearance holes which can insert the embossments 112f to 112i, 112p to 112s. In the structure, as illustrated in FIG. 15B, the mounting bearing surface 113d of the rear side plate 113 is abutted to the third bearing surface 112t which is formed with the end surfaces of the higher embossments 112p to 112s. Therefore, the separation distance between the central axis of the fitting hole 112d formed in the bearing portion 112a of the fixed-side hinge plate 112 and the mounting bearing surface 113d of the rear side plate 113 is set to be the separation distance h2.

FIGS. 16 to 18 show a structure in which the mounting bearing surface 113d of the rear side plate 113 has the clearance holes 113p to 113s which can insert only the higher embossments 112p to 112s.

The elongated guide holes 112b, 112c, of which longitudinal direction is arranged in an orthogonal direction with respect to the central axis of the fitting hole 112d fitting the hinge shaft 119 formed in the movable side hinge plate 114, are formed on the fixed-side hinge plate 112, being aligned in a straight line. Further, the elongated screw-insertion hole 112j is formed to insert the screw 121.

The first bearing surface 112k of the fixed-side hinge plate 112 is provided with the embossments 112f to 112i, 112p to 112s which are projected therefrom around the elongated screw-insertion hole 112j in eight directions.

On the other hand, the guide embossments 113b, 113c are arranged on the rear side plate 113 in a horizontal direction of the main body of the image forming apparatus 100. The guide embossments 113b, 113c are inserted into the elongated guide holes 112b, 112c of the fixed-side hinge plate 112, respectively, to be movably fitted along the elongated guide holes 112b, 112c.

Further, the rear side plate 113 is provided with the clearance hoes 113p to 113s in respective positions corresponding to the higher embossments 112p to 112s which are formed on the fixed-side hinge plate 112, so as to insert the higher embossments 112p to 112s.

The screw 121 is inserted into the elongated screw-insertion hole 112j formed in the fixed-side hinge plate 112 to be threadably coupled to the screw hole 113a formed in the rear side plate 113. With this arrangement, the fixed-side hinge plate 112 can be locked and fixed to the rear side plate 113.

As illustrated in FIGS. 16 to 18, in the structure in which the mounting bearing surface 113d of the rear side plate 113 has the clearance holes 113p to 113s which can insert only the higher embossments 112p to 112s, the higher embossments 112p to 112s escape through the clearance holes 113p to 113s.

Therefore, as illustrated in FIG. 18B, the mounting bearing surface 113d of the rear side plate 113 is abutted to the second bearing surface 112m which is formed with the end faces of the lower embossments 112f to 112i. With this arrangement, the separation distance between the central axis of the fitting hole 112d formed in the bearing portion 112a of the fixed-side hinge plate 112 and the mounting bearing surface 113d of the rear side plate 113 is set to be a separation distance h3 (h3<h2).

FIGS. 19 to 21 show the structure having the clearance holes 113p to 113s, 113f to 113i which can insert the higher embossments 112p to 112s and the lower embossments 112f to 112i, respectively.

The elongated guide holes 112b, 112c, which longitudinal direction is arranged in an orthogonal direction with respect to the central axis of the fitting hole 112d, are formed in the fixed-side hinge plate 112, being aligned in a straight line. Further, the elongated screw-insertion hole 112j is formed to insert the screw 121.

The first bearing surface 112k of the fixed-side hinge plate 112 is provided with the embossments 112f to 112i, 112p to 112s, which are projected from the first bearing surface 112k around the elongated screw-insertion hole 112j in eight directions.

On the other hand, the guide embossments 113b, 113c are arranged on the rear side plate 113 in a horizontal direction of the main body of the image forming apparatus 100. The guide embossments 113b, 113c are inserted into the elongated guide holes 112b, 112c, respectively, to be movably fitted in along the elongated guide holes 112b, 112c.

In addition, in the rear side plate 113, the clearance holes 113p to 113s which can insert the higher embossments 112p to 112s are formed on respective positions corresponding to the higher embossments 112p to 112s. Further, in the rear side plate 113, the clearance holes 113f to 113i which can insert the lower embossments 112f to 112i are formed on respective positions corresponding to the lower embossments 112f to 112i.

The screw 121 is inserted into the elongated screw-insertion hole 112j to be threadably coupled to the screw hole 113a formed in the rear side plate 113. With this arrangement, the fixed-side hinge plate 112 can be locked and fixed to the rear side plate 113.

In the structure illustrated in FIGS. 19 to 21, the mounting bearing surface 113d of the rear side plate 113 has the clearance holes 113p to 113s, 113f to 113i, which can insert the higher embossments 112p to 112s and the lower embossments 112f to 112i, respectively. In the structure, the higher embossments 112p to 112s and the lower embossments 112f to 112i escape through the clearance holes 113p to 113s, 113f to 113i, respectively.

Therefore, as illustrated in FIG. 21B, the first bearing surface 112k of the fixed-side hinge plate 112 is abutted to the mounting bearing surface 113d of the rear side plate 113. With this arrangement, the separation distance between the central axis of the fitting hole 112d formed in the bearing portion 112a of the fixed-side hinge plate 112 and the mounting bearing surface 113d of the rear side plate 113 is set to be a separation distance h4 (h4<h3<h2).

According to the embodiment, in the door 101 illustrated in FIG. 1, the bearing surface 113d of the rear side plate 113, illustrated in FIGS. 13 to 15, has no clearance holes which can insert the embossments 112f to 112i, 112p to 112s. With this arrangement, the separation distance between the central axis of the fitting hole 112d formed in the bearing portion 112a of the fixed-side hinge plate 112 and the mounting bearing surface 113d of the rear side plate 113 is set to be the separation distance h2 (h2>h3>h4), as illustrated in FIG. 15A.

In the upper door 101X illustrated in FIG. 1, the bearing surface 113d of the rear side plate 113, illustrated in FIGS. 16 to 18, has the clearance holes 113p to 113s which can insert only the higher embossments 112p to 112s. With this arrangement, the separation distance between the central axis of the fitting hole 112d formed in the bearing portion 112a of the fixed-side hinge plate 112 and the mounting bearing surface 113d of the rear side plate 113 is set to be the separation distance h3 (h2>h3>h4), as illustrated in FIG. 18A.

In a reverse door 101R illustrated in FIG. 1, the bearing surface 113d of the rear side plate 113, illustrated in FIGS. 19 to 21, has the clearance holes 113p to 113s, 113f to 113i which can insert the higher embossments 112p to 112s and the lower embossments 112f to 112i, respectively. With this arrangement, the separation distance between the central axis of the fitting hole 112d formed in the bearing portion 112a of the fixed-side hinge plate 112 and the mounting bearing surface 113d of the rear side plate 113 is set to be the separation distance h4 (h2>h3>h4), as illustrated in FIG. 21A. The reverse door 101R, illustrated in FIG. 1, is rotated around a rotation center formed at a front side of the image forming apparatus 100 in a vertical direction so as to open a reverse conveyance path 2 which extends in a vertical direction.

Further, as another embodiment similar to each of the embodiments described above, a plurality of embossments which are projection portions having different projecting heights are formed on the mounting bearing surface of the movable side hinge plate 114 fixed to a side of the door 101, as illustrated in FIG. 2, so that level differences can be formed. In case of sheet metal press, by using a half blanking process or a draw forming process, a projected surface can be made, in which embossments are arranged on a periphery of a screw hole, projecting in parallel and having different heights, similar to the embodiments described above.

In this case, the structure is a combination of individual components formed of the mounting bearing surface of the movable side hinge plate 114 of the side of the door 101 and the mounting bearing surface of the fixed-side hinge plate 112 of the main body side of the image forming apparatus 100. Thereby, the number of combinations increases so as to be a product of the number of different heights of embossments on one side multiplied by the one on the other side (example: a product of three levels on the fixed-side hinge plate 112 by two levels on the movable side hinge plate 114 is six levels in total). Therefore, flexible arrangements can be obtained according to variations in level difference of heights of a plurality of doors provided in the image forming apparatus 100, making it possible to be standardized and universalized. The structure in the other embodiment is made similar to that of the first embodiment described as above, having similar advantages.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2012-101864, filed Apr. 26, 2012, which is hereby incorporated by reference herein in its entirety.

What is claimed is:

1. A hinge mechanism arranged between a main body and a door, and openably and closably supporting the door, comprising:
a fixed-side hinge plate disposed at the main body; and
a movable side hinge plate disposed at the door,
wherein the fixed-side hinge plate includes a bearing surface and a plurality of projection portions projected from the bearing surface, and
the fixed-side hinge plate is mountable to
(1) a first mounting portion of the main body, having holes through which the projection portions can be inserted, and being capable of abutting to the bearing surface, and
(2) a second mounting portion of the main body, being capable of abutting to end surfaces of the plurality of projection portions.

2. The hinge mechanism according to claim 1, wherein the fixed-side hinge plate has various levels of the end surfaces of the plurality of projection portions projected from the bearing surface, varying at least in height.

3. The hinge mechanism according to claim 1, wherein one hinge plate out of the fixed-side hinge plate and the movable side hinge plate has a hinge shaft, and the other plate thereof has a bearing portion having a fitting hole in which the hinge shaft is detachably fitted.

4. The hinge mechanism according to claim 3, wherein
the main body has a screw hole and a plurality of guide embossments, and
the fixed-side hinge plate has elongated guide holes which have a longitudinal direction in an orthogonal direction with respect to a central axis of the fitting hole and through which the guide embossments are inserted, and an elongated screw-insertion hole corresponding to the screw hole.

5. The hinge mechanism according to claim 3, wherein a slit orthogonal to an axial direction of the fitting hole is formed in a midstream of an axial direction of the fitting hole of the bearing portion, and a removal stopper member is attached through the slit so as to be fitted into a groove formed in the hinge shaft.

6. The hinge mechanism according to claim 3, wherein one end portion of one hinge plate out of the fixed-side hinge plate and the movable side hinge plate has an L-shaped cross section, and substantially-right-angled abutting surfaces formed on an outer circumferential surface of the hinge shaft are abutted and fixed to the hinge plate along an inner circumferential surface of the L-shaped cross section.

7. An image forming apparatus, comprising:
an image forming apparatus main body;
a door; and
the hinge mechanism according to claim 1, wherein
the hinge mechanism is arranged between the image forming apparatus main body and the door, and openably and closably support the door.

8. An image forming apparatus having a door capable of opening and closing via a hinge portion, comprising a fixed-side hinge plate disposed at an image forming apparatus main body has a bearing surface and a plurality of projection portions projected from the bearing surface, wherein
the fixed-side hinge plate is adapted to be mountable to
(1) a first mounting portion of the image forming apparatus main body, having holes through which can insert the projection portions can be inserted, and being capable of abutting to the bearing surface, and
(2) a second mounting portion of the image forming apparatus main body, being capable of abutting to end surfaces of the plurality of projection portions.

9. The image forming apparatus according to claim 8, wherein the fixed-side hinge plate has various levels of the end surfaces of the plurality of projection portions projected from the bearing surface, varying at least in height.

10. The image forming apparatus according to claim 8, wherein one hinge plate out of the fixed-side hinge plate and the movable side hinge plate disposed at the door has a hinge shaft, and the other hinge plate thereof has a bearing portion having a fitting hole in which the hinge shaft is detachably fitted.

11. The image forming apparatus according to claim 10, wherein
the image forming apparatus main body has a screw hole and a plurality of guide embossments, and
the fixed-side hinge plate has elongated guide holes which have a longitudinal direction in an orthogonal direction with respect to a central axis of the fitting hole and through which the guide embossments are inserted, and the elongated screw-insertion hole corresponding to the screw hole.

12. The image forming apparatus according to claim 10, wherein
a slit orthogonal to an axial direction of the fitting hole is formed in a midstream of an axial direction of the fitting hole of the bearing portion, and
a removal stopper member is attached through the slit so as to be fitted into a groove formed in the hinge shaft.

13. The image forming apparatus according to claim 10, wherein one end portion of one hinge plate out of the fixed-side hinge plate and the movable side hinge plate has an L-shaped cross section, and substantially-right-angled abutting surfaces formed on an outer circumferential surface of the hinge shaft are abutted an fixed to the hinge plate along an inner circumferential surface of the L-shaped cross section.

14. The image forming apparatus according to claim 10, wherein
the door is openably and closably disposed to the image forming apparatus main body via an upper and a lower hinge portions,
the fixed-side hinge plate and the movable side hinge plate are fixed to a mounting bearing surface of a side of the image forming apparatus main body and a mounting bearing surface of a side of the door, respectively, such that one of the hinge shafts of the upper and lower hinge portions is removed in an upward direction before the other is removed, and
when the door is detached from the image forming apparatus main body, the door is slid along the hinge shaft in an upward direction to be disengaged.
